(19) United States
(12) Patent Application Publication
(10) Pub. No.: US 2008/0142728 A1
(43) Pub. Date: Jun. 19, 2008

(54) Mechanical scanner

(75) Inventors: Theodore Smick, Essex, MA (US); Ronald Horner, Auburndale, MA (US); Causon Jen, San Jose, CA (US)

Correspondence Address: Robert W. Mulcahy;Applied Materials, Inc., Box 450A, Santa Clara, CA, 95052, US

(73) Assignee: APPLIED MATERIALS, INC.

(21) Appl. No.: 11/589,281

(22) Filed: Oct. 30, 2006

(51) Int. Cl. G01K 1/08

(52) U.S. Cl. 250/400

(57) ABSTRACT

A mechanical scanner for ion implantation of a substrate, the mechanical scanner comprising a hexapod with a movable platform for holding the substrate, wherein the hexapod is arranged to have six degrees of freedom to allow the movable platform to be traversed relative to an ion beam along a predetermined path.

### FIELD OF THE INVENTION

The present invention relates to a mechanical scanner, and in particular a mechanical scanner for ion implantation of a substrate.

### BACKGROUND OF THE INVENTION

Ion implanters are commonly used in the manufacture of semiconductor products for implanting ions in semiconductor substrates to change the conductivity of the material in predefined regions. Ion implanters generally include an ion beam generator for generating a beam of ions, a mass analyser for selecting a particular specie of ions in the ion beam and means to direct the ion beam onto a target substrate. To allow uniformity of ion implantation typically an ion beam is scanned across the surface of a substrate. As such, the cross sectional area of the ion beam is typically less than the surface area of the substrate, which necessitates traversal of the ion beam over the substrate in a one or two-dimensional scan so that the ion beam covers the whole surface of the substrate. Three two dimensional scanning techniques commonly employed in ion implantation are (i) electrostatic and/or magnetic deflection of the ion beam relative to a static substrate; (ii) mechanical scanning of the target substrate in two dimensions relative to a static ion beam; and (iii) a hybrid technique involving magnetic or electrostatic deflection of the ion beam in one direction and mechanical scanning of the target substrate in another generally orthogonal direction.

With respect to two dimensional mechanical scanners, the mechanical scanners typically use one fast axis in one direction and a slow axis in another generally orthogonal direction to uniformly implant dopant ions into a semiconductor substrate. For example, one technique uses two linear motions at an orthogonal direction to each other. One of the linear motions is performed at a relatively constant speed, first in a forwards direction and then the reverse direction and the other linear motion is performed in a stepwise manner to produce a raster scan.

However, an important objective in the fabrication of semiconductor substrates (i.e. wafers) is to maximise the wafer throughput. As such, it is desirable to have a relatively fast scan rate and as a consequence the mass of the mechanical scanner should ideally be minimised. Further, a conventional mechanical scanner used in ion implantation needs two motors mounted on top of each other to control the movement of the wafer holder, which can result in an increase in mass of the wafer holder.

### SUMMARY OF THE INVENTION

An object of the present invention is to provide a mechanical scanner for ion implantation of a substrate having reduced mass.

In accordance with a first aspect of the present invention there is provided an ion implanter having an ion beam generator to generate a beam of ions along a beam path, a holder for a substrate to be implanted and a scanning mechanism to drive the holder in at least two dimensions transverse to the beam path such as in use to scan a said substrate on the holder through the ion beam to provide a uniform dose of desired implant species over the surface of the substrate, said scanning mechanism comprising a base, a hexapod structure having six extendable legs linking the holder to the base and actuators to control extension lengths of the legs, and a controller to control the actuators to drive said holder to effect said scanning.

Preferably said holder has a front side with a substrate supporting face having a predetermined diameter and a rear side, said legs of the hexapod structure have joint connections to said rear side located substantially within a rearward projection of said supporting face, and said legs have sufficient maximum extension lengths to enable said actuators to drive said holder parallel to said supporting face over a distance greater than said diameter.

Preferably said legs have forward ends connected to said holder and rearward ends connected to said base and said hexapod structure has respective gimbal joints connecting said rearward ends of said legs to said base and providing substantially intersecting gimbal axes, said actuators for said legs comprising a respective motor mounted on said rearward end of each said leg so as to be located rearwards of the gimbal axes of said respective gimbal joint.

Preferably said base comprises a base plate having an opening aligned with said beam path to allow a beam of ions to pass through the base plate and said legs of the hexapod structure are connected to said base plate at locations distributed around said opening.

In accordance with a second aspect of the present invention there is provided a scanning mechanism comprising a holder for a workpiece to be mechanically scanned, a base, and a hexapod structure having six extendable legs linking the holder to the base and actuators to control extension lengths of the legs to drive said holder, wherein said holder has a front side with a workpiece supporting face having a predetermined diameter and a rear side, said legs of the hexapod structure have joint connections to said rear side located substantially within a rearward projection of said supporting face, and said legs having sufficient maximum extension lengths to enable said actuators to drive said holder parallel to said supporting face over a distance greater than said diameter.

In accordance with a third aspect of the present invention there is provided a scanning mechanism comprising a holder for a workpiece to be mechanically scanned, a base, and a hexapod structure having six extendable legs linking the holder to the base and actuators to control extension lengths of the legs to drive said holder, wherein said legs have forward ends connected to said holder and rearward ends connected to said base and said hexapod structure has respective gimbal joints connecting said rearward ends of said legs to said base and providing substantially intersecting gimbal axes, said actuators for said legs comprising a respective motor mounted on said rearward end of each said leg so as to be located rearwards of the gimbal axes of said respective gimbal joint.

According to the present invention there is provided a mechanical scanner for ion implantation of a substrate, the mechanical scanner comprising a hexapod with a movable platform for holding the substrate, wherein the hexapod is arranged to have six degrees of freedom to allow the movable platform to be traversed relative to an ion beam along a predetermined path.

This provides the advantage of allowing a wafer mounted to the movable platform to be scanned and tilted, for controlling the angle of implantation, while keeping the mass of the scanning platform low. This allows faster scanning and/or lower vibration of the ion implanter. For example, as the scan frequency increases linearly the acceleration increases by its square. Consequently, a scanning mechanism that has less mass, for example avoiding the need for a number of motors to be attached to the wafer holder, will allow a significant reduction in vibration.

An example of the mass of the movable platform when performing a 1 Hz scan in the fast and slow axis is approximately 25 lbs.

Additionally, the use of a hexapod provides a very rigid structure with precise movements and high stability.

Preferably the six degrees of freedom are provided by six movable legs.

Preferably the hexapod includes six legs that are arranged to allow lateral movement of the movable platform equal to at least the length of the surface of the movable platform used for holding the substrate.

Preferably the hexapod includes six legs with at least one of the legs being mounted to a base element via a gimbal to allow pivotal movement of the at least one of the legs.

Ideally the mechanical scanner further comprising a motor mounted to the at least one of the legs behind the gimbal at an opposite end of the leg to the movable platform to allow the at least one of the legs to be extended in length.

Preferably the six legs are arranged to allow tilting of the moveable platform.

Preferably the six legs are arranged to allow rotation of the movable platform.

Preferably the hexapod is arranged to move the movable platform parallel to a first direction transverse to an ion beam used for ion implanting of a substrate and reciprocating the movable platform parallel to a second direction, transverse to the ion beam direction and the first direction to execute a plurality of scans.

Preferably the first direction and second direction and be selected from a plurality of different orientations.

Ideally the base element includes a cut-out section arranged to be formed in line with an ion beam to allow ion particles in the ion beam that have not already impacted with the mechanical scanner to pass through the base element.

In a further aspect of the present invention there is provided a mechanical scanner for ion implantation of a substrate, the mechanical scanner comprising a hexapod with a movable platform for holding the substrate, wherein the hexapod is arranged to have six degrees of freedom to allow the movable platform to be traversed relative to an ion beam along a predetermined path, wherein the hexapod includes six legs that are arranged to allow lateral movement of the movable platform equal to at least the length of the surface of the movable platform for holding the substrate.

In a further aspect of the present invention there is provided a mechanical scanner for ion implantation of a substrate, the mechanical scanner comprising a hexapod with a movable platform for holding the substrate, wherein the hexapod is arranged to have six degrees of freedom to allow the movable platform to be traversed relative to an ion beam along a predetermined path, wherein the hexapod includes six legs with at least one of the legs being mounted to a base element via a gimbal to allow pivotal movement of the at least one of the legs further comprising a motor mounted to the at least one of the legs behind the gimbal at an opposite end of the leg to the movable platform to allow the at least one of the legs to be extended in length.

### BRIEF DESCRIPTION OF THE DRAWINGS

Examples of embodiments of the present invention will now be described with reference to the drawings, in which:

FIG. 1 is a schematic view of an ion implanter having a wafer holder for serial processing of a wafer;

FIG. 2 is a schematic representation showing an ion beam scanning across a wafer;

FIG. 3 illustrates a hexapod according to an embodiment of the present invention;

FIG. 4 illustrates a hexapod leg according to an embodiment of the present invention;

FIG. 5 illustrates a hexapod according to an embodiment of the present invention positioned at the start of a raster scan;

FIG. 6 illustrates a hexapod according to an embodiment of the present invention positioned part way through a raster scan.

### DETAILED DESCRIPTION OF THE PREFERRED EMBODIMENTS

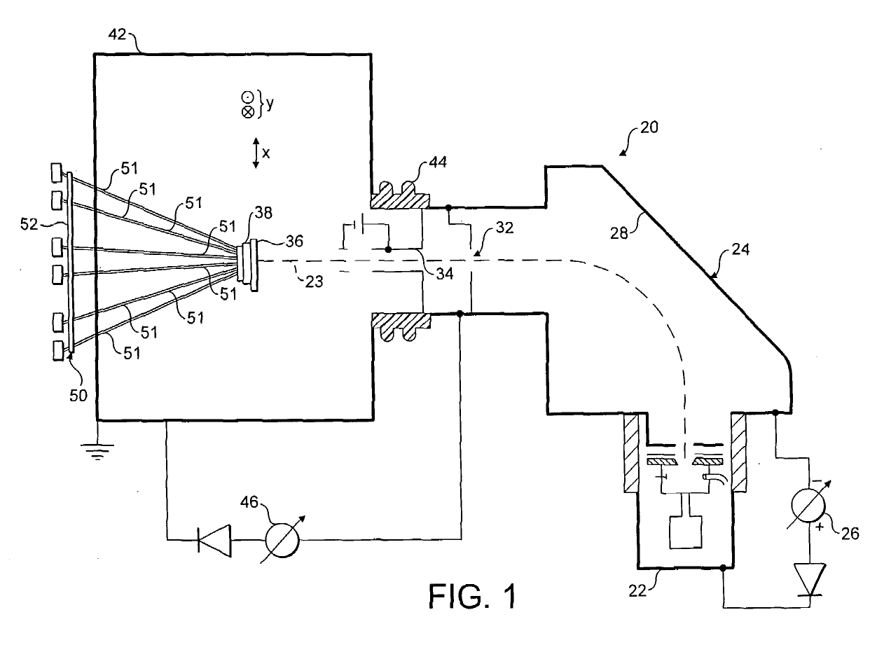

FIG. 1 shows a typical ion implanter 20 comprising an ion beam source 22 such as a Freeman or Bernas ion source that is supplied with a pre-cursor gas for producing an ion beam 23 to be implanted into a wafer 36. The ions generated in the ion source 22 are extracted by an extraction electrode assembly. A flight tube 24 is electrically isolated from the ion source 22 and a high-tension power supply 26 supplies a potential difference therebetween.

The potential difference between the flight tube 24 and the ion source 22 causes positively charged ions to be extracted from the ion source 22 into the flight tube 24. The flight tube 24 includes a mass-analysis arrangement comprising a mass-analysing magnet 28 and a mass-resolving slit 32. Upon entering the mass-analysis apparatus within the flight tube 24, the electrically charged ions are deflected by the magnetic field of the mass-analysis magnet 28. The radius and curvature of each ion's flight path is defined, through a constant magnetic field, by the mass/charge ratio of the individual ions.

The mass-resolving slit 32 ensures that only ions having a chosen mass/charge ratio emerge from the mass analysis arrangement. The ion beam 23 is then turned by the mass-analysing magnet 28 to travel along the plane of the paper. Ions passing through the mass-resolving slit 32 enter a tube 34 that is electrically connected to and integral with the flight tube 24. The mass-selected ions exit the tube 34 as an ion beam 23 and strike a semiconductor wafer 36 mounted upon a movable platform 38 (i.e. a wafer holder). A beamstop (not shown) will typically be located behind (i.e. downstream of) the wafer holder 38 to intercept the ion beam 23 when not incident upon the wafer 36 or wafer holder 38. The wafer holder 38 is a serial processing wafer holder 38 and so only holds a single wafer 36. The wafer holder 38 is operable to move along X and Y axes using a hexapod 50, as described below, the direction of the ion beam 23 defining the Z axis of a Cartesian coordinate system. As can be seen from FIG. 1, the X axis extends parallel to the plane of the paper, whereas the Y axis extends into and out from the plane of the paper.

To maintain the ion beam current at an acceptable level, an ion extraction energy is set by a regulated high-tension power supply 26: the flight tube 24 is at a negative potential relative to the ion source 22 by virtue of this power supply 26. The ions are maintained at this energy throughout the flight tube 24 until they emerge from the tube 34. It is often desirable for the energy with which the ions impact the wafer 36 to be considerably lower than the extraction energy. In this case, a reverse bias voltage must be applied between the wafer 36 and the flight tube 24. The wafer holder 38 is contained within a process chamber 42 that is mounted relative to the flight tube 24 by insulating standoffs 44, where the process chamber is maintained in a vacuum condition, or substantially vacuum condition, during ion implantation. The wafer holder 38 is connected to the flight tube 24 via a deceleration power supply 46. The wafer holder 38 is held at a common ground potential so that, to decelerate the positively-charged ions, the deceleration power supply 46 generates a negative potential with respect to the grounded wafer holder 38 at the flight tube 24.

In some situations, it is desirable to accelerate the ions prior to implantation in the wafer 36. This is most easily achieved by reversing the polarity of the power supply 46. In other situations, the ions are left to drift from flight tube 24 to wafer 36, i.e. without acceleration or deceleration. This can be achieved by providing a switched current path to short out the power supply 46.

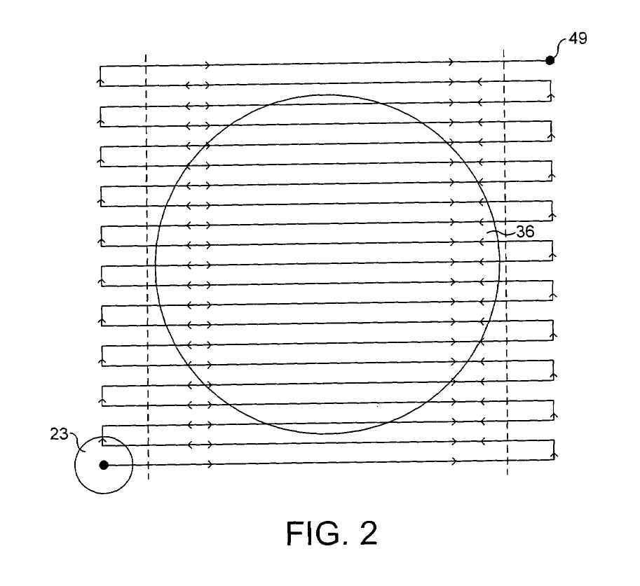

Movement of the wafer holder 38 is controlled using the hexapod 49 such that the fixed ion beam 23 scans across the wafer 36 according to the raster pattern 49 shown in FIG. 2. However, other scan patterns can be performed. In particular, the use of a hexapod allows a circular scan to be performed, which can not only decrease the total time required to scan a wafer but also requires less lateral movement of the wafer, thereby reducing a potential source of vibration. When using a circular scan the scanning mechanism may not need a fast and slow axis, but the scanning may be performed in a slow constant moving scan. However, a slow constant scan can also be adopted for a convention raster type can.

The ion beam 23 has a typical diameter of 50 mm, whereas the wafer 36 has a diameter of 300 mm (200 mm also being common for semiconductor wafers). In this example, a pitch of 2 mm in the Y-axis direction is chosen, leading to a total of 175 scan lines (i.e. n=175) to ensure the full extent of the ion beam 23 is scanned over the full extent of the wafer 36. Only 21 scan lines are shown in FIG. 2 for the sake of clarity.

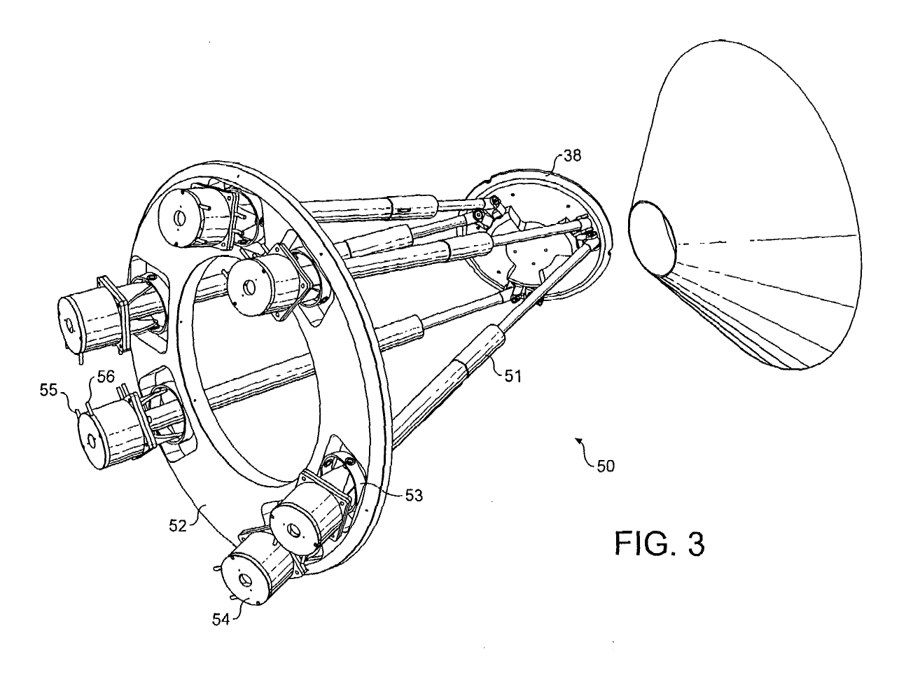

The hexapod 50, of the ion implanter 20, is illustrated in FIG. 3. The hexapod 50 includes the wafer holder 38 coupled to the end of six legs 51 via respective universal joints. The opposite ends of each of the six hexapod legs 51 are mounted to a base 52.

The base 52 is annular in shape, with six cut-out sections formed in the annular portion through which the respective legs 51 are mounted via a gimbal 53. Each gimbal 53 has two pairs of pivots mounted on axis at right angles, as is well known to a person skilled in the art.

Mounted at the end of each leg 51, at the opposite end to the wafer holder 38, is a motor 54 mounted in a cantilevered manner behind each respective gimbal 53.

Although FIG. 1 shows the hexapod 50 only partially enclosed within the process chamber 42, so that the part of the hexapod 50 that is not included within the process chamber need not be maintained in a vacuum environment, the hexapod 50 can also be fully enclosed within the process chamber 42.

Where the hexapod 50 is partially enclosed within the process chamber 42, the base 52 can either be included or excluded from the process chamber 42. If, however, the base 52 is excluded from the process chamber 42 typically a beamstop will be included in the process chamber, in front of the base 52. If the base 52 is included within the process chamber 42 the beamstop can either be placed in front or behind the base 52. As the base 52 is annular in shape, ion particles that are not incident upon the wafer 36 mounted on the wafer holder 38 or the wafer holder 38 will pass through the base 52 to the beamstop.

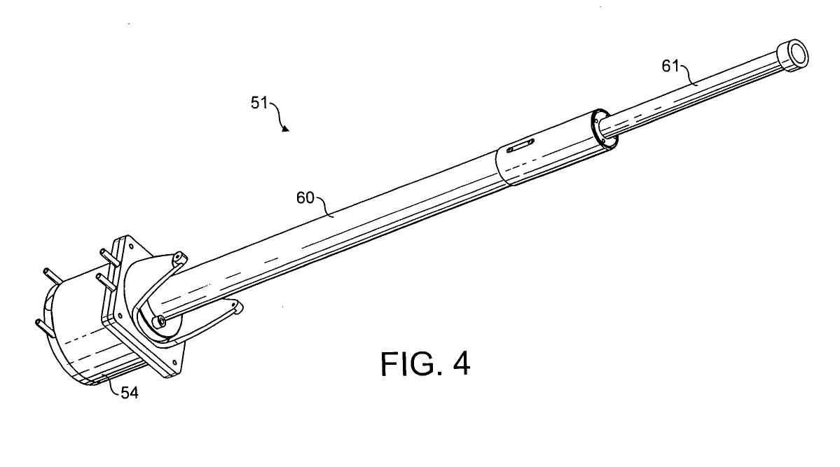

As shown in FIG. 4, each hexapod leg 51 includes a first section 60 and a second section 61. The first section 60 is mounted to the base 52, via a gimbal 53, and has a motor 54 mounted at the end of the first section 60 for rotating the first section 60 around it's longitudinal axis. Preferably the motor 54 is arranged to be cooled by use of a cooling fluid, for example water, that is circulated around the motor via a fluid inlet 55 and fluid outlet 56. An umbilical arrangement (not shown) can also be used to providing connections to the wafer holder 38 from the base 52, for example along the legs 51. The umbilical arrangement can, for example, be used for providing cooling fluids to the wafer holder 38.

The second section 61 is mounted to the wafer holder 38. The first section 60 of the leg 51 is coupled to the second section 61 of the leg 51 via a screw arrangement that is formed using a rib and groove arrangement. For the purposes of the present embodiment the second section 61 of the leg 51 is screw fitted in a hollowed-out section of the first section 60 of the leg 51, where the hollowed-out section of the first section 60 of the leg 51 runs through the length of the first section 60 of the leg 51. The hollowed-out section of the first section 60 of the leg 51 and the outer surface of the second section 61 of the leg 51 have a rib and groove arrangement so that axial rotation of either the first section 60 or second section 61 of the leg 51 causes the leg 51 to extend or contract.

As stated above, each motor 54 attached to a respective leg 51 is arranged to rotate the respective first section 60 of each leg 51, thereby allowing each leg 51 to extend or contract depending upon the direction of rotation.

Having a motor 54 attached to the end of a hexapod leg 51, rather that being incorporated within a hexapod leg at the junction between the first and second section of the hexapod leg 51, allows the hexapod leg diameters to be minimised. As such, for a given base diameter this allows a greater range of movement for the hexapod legs 51, thereby increasing the range of movement of the wafer holder 38.

In an alternative embodiment, however, it would be possible to include a motor 54 for rotating a hexapod leg 51 within one or more or all of the hexapod legs 51, for example at the junction between the first section 60 and the second section 61 of a hexapod leg 51, rather than at the end of a hexapod leg. Within this alternative embodiment, a hexapod leg 51, within which a motor 54 was mounted, could be mounted to the base via a universal joint. As such, one or more or all of the hexapod legs 51 could be mounted to the base via a universal joint.

The position of the wafer holder 38 is moved, tilted and/or rotated by varying the length of the respective six legs 51 using the respective motors 54, which would be well understood by a person skilled in the art. By mounting the six legs 51 to the base 52, via gimbals 53, and to the wafer holder 38, via universal joints, the hexapod 50 is able to provide six degrees of freedom in the movement of the wafer holder 38, thereby allowing rotation of the wafer holder 38 in addition to movement of the wafer holder 38 in the X, Y and Z axis.

By varying the length of appropriate hexapod legs 51 to cause the wafer holder 38 to rotate, the position of a wafer 36 mounted on the wafer holder 38 can be matched to the profile of the ion beam 23. For example, if the cross sectional profile of the ion beam 23 is oblong, rather than circular, it is desirable that the fast axis of a raster scan for a wafer be scanned along the line of the broadest section of the ion beam 23. Accordingly, by rotating the wafer holder 38 to match the fast axis of the raster scan to the broadest section of the ion beam 23 it is possible to match the raster orientation of the wafer holder 38 to the profile of the ion beam 23.

Further, by using a controller (not shown) to synchronise the operation of the six respective motors 54 it is possible, as stated above, to scan the wafer holder 38, relative to the ion beam 23, according to the raster pattern 49 shown in FIG. 2. However, the controller can be configured to control the length of the hexapod legs 51 to provide a variety of different scan patterns, with the wafer holder 38 rotated in a variety of different directions.

To allow a raster scan to be performed across a complete wafer 36 that is mounted to the wafer holder 38, the hexapod legs 51 are arranged to have a length, range of movement, maximum angle of rotation that allows lateral movement of the wafer holder 38 equal to at least the length of the surface of the wafer holder 38. For example, for a wafer holder 38 that is 300 mm in diameter, with hexapod legs that have a maximum angle of rotation of 45 degrees, the minimum length of the hexapod legs should be approximately 213 mm to allow the wafer holder 38 to move 300 mm in a lateral direction.

To avoid a large vacuum chamber to house the hexapod, or part of the hexapod, it would be desirable to keep the hexapod leg lengths to a minimum, which may result in an increased angle of rotation.

Preferably, however, the length, range of movement and maximum angle of rotation is such to allow lateral movement of the wafer holder 38 equal to the length of the surface of the wafer holder 38 and the width of the ion beam 23. For example, for the purposes of the current embodiment the hexapod 50 is configured to provide the wafer holder 38 with lateral movement of at least 300 mm, to accommodate the wafer holder 38 diameter, plus 50 mm, to accommodate the diameter of the ion beam 23.

Accordingly, at the start of a raster scan the wafer holder 38 can be moved laterally so that the wafer holder 38 is moved to the side of the ion beam 23, thereby avoiding ion particles impinging upon the wafer 36 and wafer holder 38. During the raster scan the length of the hexapod legs 51 are varied, causing the wafer holder 38 to move across the ion beam 23 according to the raster scan 49 as illustrated in FIG. 2.

Alternatively, if a raster scan does not need to performed over the whole of a wafer 36 the lengths of the hexapod legs 51, in combination with their angle of rotation, do not need to be long enough to allow lateral movement of the wafer holder 38 equal to at least the length of the surface of the wafer holder 38.

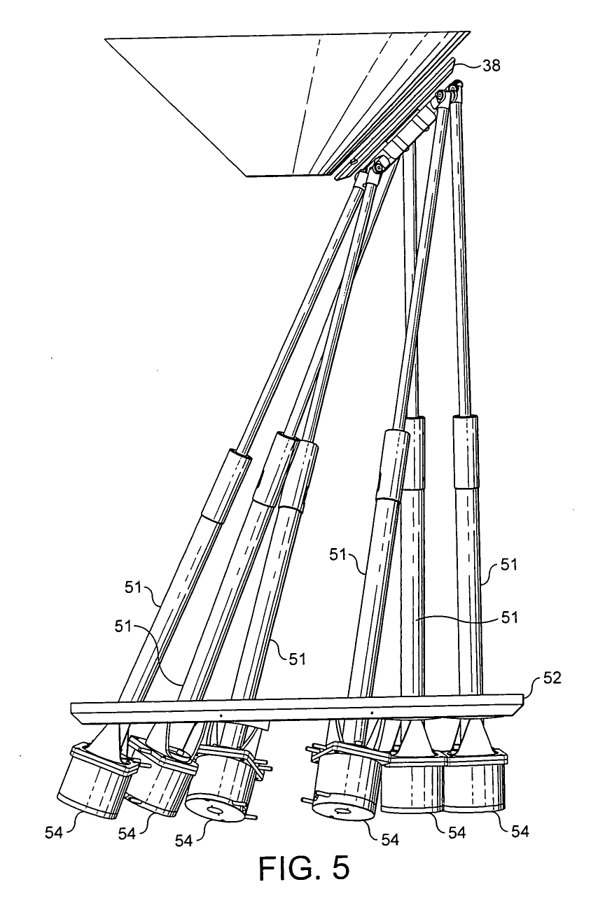

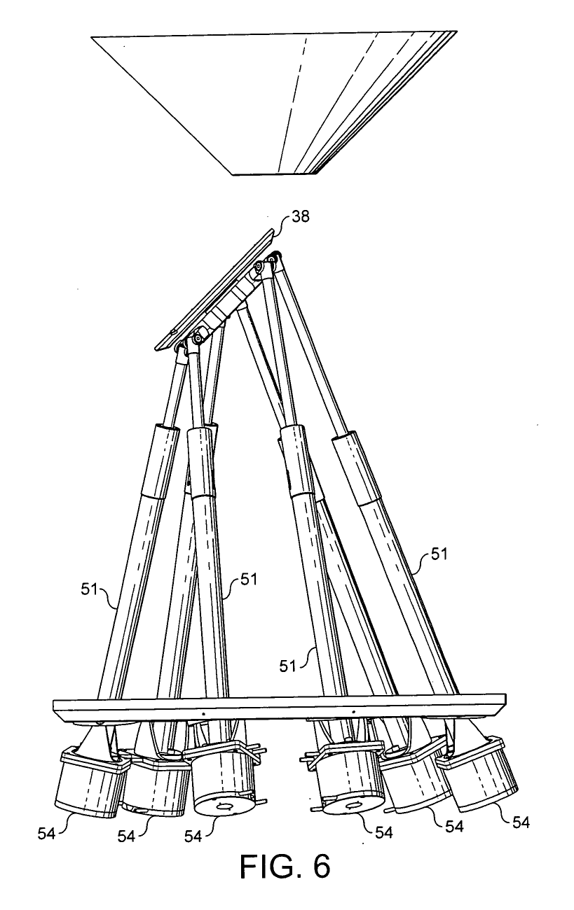

Additionally, by controlling the length of the hexapod legs 51 the wafer holder 38 can be scanned across the ion beam 23 at angles other than perpendicular to the ion beam 23. For example, FIG. 5 shows a hexapod 50 having a wafer holder 38 that has been tilted at an angle of approximately 45 degrees relative to the ion beam 23 to allow an angled isocentric raster scan to be performed. The hexapod legs 51 are arranged to move the wafer holder 38 according to the raster scan shown in FIG. 2 while maintaining an angle of approximately 45 degrees to the ion beam 23. FIG. 6 shows the wafer holder 38 having been moved towards the end of a raster scan line. However, as a person skilled in the art would appreciate, the wafer holder 38 can be scanned perpendicularly to the ion beam 23, or at a variety of other angles. In addition to being tilted the wafer 38 can be rotated to allow implanting of a substrate on the wafer holder 38 in a variety of orientations.

Further, the controller can be arranged to vary the lengths of the hexapod legs 51 to perform a non-isocentric scan relative to the ion beam 23.

It will be apparent to those skilled in the art that the disclosed subject matter may be modified in numerous ways and may assume embodiments other than the preferred forms specifically set out as described above, for example the hexapod legs 51 could be mounted to the wafer holder 38 via gimbals. Further, if only limited range of movement is required it may be possible to reduce the number of legs, for example having a five or four legged hexapod. Additionally, to further reduce vibration caused as a result of the movement of the wafer holder, it is possible to include a reaction system to the hexapod to counter act the vibration effects.

1. An ion implanter having an ion beam generator to generate a beam of ions along a beam path, a holder for a substrate to be implanted and a scanning mechanism to drive the holder in at least two dimensions transverse to the beam path such as in use to scan a said substrate on the holder through the ion beam to provide a uniform dose of desired implant species over the surface of the substrate,
said scanning mechanism comprising a base, a hexapod structure having six extendable legs linking the holder to the base and actuators to control extension lengths of the legs, and a controller to control the actuators to drive said holder to effect said scanning.

2. An ion implanter as claimed in claim 1, wherein said holder has a front side with a substrate supporting face having a predetermined diameter and a rear side, said legs of the hexapod structure have joint connections to said rear side located substantially within a rearward projection of said supporting face, and said legs have sufficient maximum extension lengths to enable said actuators to drive said holder parallel to said supporting face over a distance greater than said diameter.

3. An ion implanter as claimed in claim 1, wherein said legs have forward ends connected to said holder and rearward ends connected to said base and said hexapod structure has respective gimbal joints connecting said rearward ends of said legs to said base and providing substantially intersecting gimbal axes, said actuators for said legs comprising a respective motor mounted on said rearward end of each said leg so as to be located rearwards of the gimbal axes of said respective gimbal joint.

4. An ion implanter as claimed in claim 1, wherein said base comprises a base plate having an opening aligned with said beam path to allow a beam of ions to pass through the base plate and said legs of the hexapod structure are connected to said base plate at locations distributed around said opening.

5. A scanning mechanism comprising a holder for a workpiece to be mechanically scanned, a base, and a hexapod structure having six extendable legs linking the holder to the base and actuators to control extension lengths of the legs to drive said holder,
wherein said holder has a front side with a workpiece supporting face having a predetermined diameter and a rear side,
said legs of the hexapod structure have joint connections to said rear side located substantially within a rearward projection of said supporting face, and said legs having sufficient maximum extension lengths to enable said actuators to drive said holder parallel to said supporting face over a distance greater than said diameter.

6. A scanning mechanism comprising a holder for a workpiece to be mechanically scanned, a base, and a hexapod structure having six extendable legs linking the holder to the base and actuators to control extension lengths of the legs to drive said holder,
wherein said legs have forward ends connected to said holder and rearward ends connected to said base and said hexapod structure has respective gimbal joints connecting said rearward ends of said legs to said base and providing substantially intersecting gimbal axes, said actuators for said legs comprising a respective motor mounted on said rearward end of each said leg so as to be located rearwards of the gimbal axes of said respective gimbal joint.
